(19) United States
(12) Patent Application Publication
(10) Pub. No.: US 2008/0256913 A1
(43) Pub. Date: Oct. 23, 2008

(54) SYSTEMS FOR PURIFYING A GAS MIXTURE COMPRISING TWO GASES USING GRANULATED POROUS GLASS

(76) Inventors: Frederick W. GIACOBBE, Naperville, IL (US); Elizabeth Giacobbe, Naperville, IL (US)

Correspondence Address: AIR LIQUIDE;Intellectual Property, 2700 POST OAK BOULEVARD, SUITE 1800, HOUSTON, TX, 77056, US

(21) Appl. No.: 11/736,395

(22) Filed: Apr. 17, 2007

(51) Int. Cl. B01D 24/10; B01D 39/06

(52) U.S. Cl. 55/523

(57) ABSTRACT

A method of separating a gas mixture comprising two gases includes the following steps. A packed bed of granulated porous glass and a gas mixture including first and second gases are provided. The gas mixture is allowed to flow into the packed bed, thereby preferentially adsorbing at least some of the first gas on the granulated porous glass to yield a purified gas having a second gas concentration of the second gas higher than that of the gas mixture. The purified gas is allowed to flow out of the packed bed. The first and second gases have boiling points or sublimation points at one atmosphere that are least 10°K apart.

### CROSS-REFERENCE TO RELATED APPLICATIONS

This application is related to expired Provisional Appl. No. 60/603,309 filed on Aug. 20, 2004 and non-provisional patent application entitled “METHODS OF PURIFYING A GAS MIXTURE COMPRISING TWO GASES USING GRANULATED POROUS GLASS”, filed on even date herewith and is incorporated by reference.

### BACKGROUND

A frequently used method of purifying gases such as Hydrogen or Helium involves cryogenic trapping of impurities entrained within these gases. In this kind of process, contaminants are removed by condensation, or adsorption, or by “freezing out” as solids within a low temperature adsorption bed. Often, at least one adsorption bed employed in using this kind of technique involves the use of activated Carbon (or activated charcoal, zeolitic molecular sieves, activated alumina, silica gels, and the like, as well as combinations of these conventional adsorbents) in a low temperature adsorption process. One proposed solution includes that disclosed by: Kidnay, A. J., Hiza, M. J., and Dickson, P. F., The Kinetics of Adsorption of Methane and Nitrogen from Hydrogen Gas, Advances in Cryogenic Engineering, Vol. 14, K. D. Timmerhaus (Editor), Plenum Press, NY 1969, pp. 41-48.

Many adsorbents are used in the field of gas separation, one of which includes silica gel. Silica gel is a granular, highly porous form of silica (SiO₂). Generally speaking, it is formed by reaction of a sodium silicate solution with a mineral acid such as HCl or H₂SO₄, followed by polymerization of the produced hydrosol. Because of the —OH functional groups, silica gel is a relatively polar material.

### SUMMARY

A system for separating a gas mixture of two gases includes: a) a source of a gas mixture comprising first and second gases having boiling points or sublimation points at one atmosphere that are least 10°K apart; b) at least one purification element operatively associated with the source of a gas mixture and being adapted and configured to selectively receive a flow of the gas mixture, said purification element comprising a vessel containing at least one packed bed of granulated porous glass; and c) a purified gas conduit adapted and configured to receive a purified gas from the at least one purification unit and direct the purified gas to a container or point of use.

### DESCRIPTION OF PREFERRED EMBODIMENTS

In general, a gas mixture containing two gases may be purified by using a packed bed of porous glass as an adsorbent. This may occur when the boiling points of those two gases (at one atmosphere) are separated by at least 10°K. The purification/separation occurs because of the tendency for the higher boiling point gas to be preferentially adsorbed on the porous glass. It is understood that the separation need not occur at one atmosphere. Indeed, a lower or higher pressure may be utilized. That being said, the gas mixture is preferably at a pressure higher than one atmosphere during performance of the invention.

Generally speaking, the higher the boiling point difference between the two gases, the more efficient the gas separation becomes. Gases such as Hydrogen and Helium have the lowest boiling points of all common gases. Therefore, it is possible to purify either Hydrogen or Helium from all other gases using the disclosed method and system. Boiling points (or in the case of Carbon Dioxide) for various gases at one atmosphere are found in Table I.

TABLE 1
Boiling Points of Some Common Gases

| Gas | Boiling Point (° K) |
|---|---|
| Argon | 87.4 |
| Helium | 4.3 |
| Hydrogen | 20.4 |
| Krypton | 120.3 |
| Methane | 111.7 |
| Neon | 27.3 |
| Nitrogen | 77.4 |
| Oxygen | 90.2 |
| Carbon Dioxide | 194.7* |
| Water | 373 |
| Xenon | 165.0 |

*Sublimation temperature at 1.0 atmosphere.

Practice of the disclosed method and system involves a flow of a gas mixture (including a first gas and a second gas) into a packed bed of granulated porous glass. The two gases have boiling points at one atmosphere that are separated by at least 10°K. The higher boiling point first gas adsorbs upon the porous glass thereby producing a purified gas having a concentration of the second gas higher than that of the gas mixture. The purified gas is then allowed to flow out of the packed bed.

Two or more packed beds of porous glass can be used so that one or more packed beds can be “off-line” while undergoing a regeneration process while other packed beds can be “on-line” and actively participating in the purification process. One of ordinary skill in the art will understand that regeneration in this context involves removal of at least some of the first gas adsorbed on the porous glass thereby increasing its ability to adsorb the first gas and consequently its ability to purify the impure gas. These steps are preferably achieved by Pressure Swing Adsorption (PSA), Vacuum Swing Adsorption (VSA), or Temperature Swing Adsorption (TSA).

The packed bed(s) are preferably regenerated with a purge gas, especially when utilizing TSA. Typical purge gases include Nitrogen, Hydrogen, Helium, Neon, Argon, and mixtures of two or more thereof. Another typical purge gas would be the purified impure gas itself. This could be the purified gas exiting another packed bed(s) or from a vessel containing the purified gas. The purge gas may be heated before or during regeneration of the packed bed. Relatively higher temperatures will enhance desorption.

If necessary, the impure gas stream may be pressurized. Also, the gas mixture stream may also be cooled by exchanging heat with the purified gas stream leaving the packed bed or by some other cooling means. Moreover, it is useful to filter the gas mixture before it enters the packed bed and/or filter the purified gas after it exits the packed bed. After purification, the purified gas may be stored for later use, immediately re-used as a purge gas, or delivered to a point-of-use in a separate process requiring the purified gas.

Preferably, the packed bed of porous glass is maintained at a very low temperature. Typical temperatures include: from about 10°K to about 78°K; from about 10°K to about 10°K; and from about 100°K to about 200°K. This is best performed by heat exchange with a heat exchange fluid such as a refrigerant. The above temperatures may be achieved in a number of different ways. For example, the packed bed may be contained within a container submerged in a liquefied gas. The temperature of the liquefied gas may be maintained within a desired range using mechanical refrigeration. As another example, the packed bed (or a container containing the packed bed) may be surrounded by a cooling jacket through which refrigerant recirculates. Numerous refrigerants are well known to those of ordinary skill in the art and need not be recited herein. The temperature of the refrigerant is maintained within a desired range using mechanical refrigeration.

The liquefied gas within which the container containing the packed bed may be submerged is preferably liquid Nitrogen for two reasons. First, its low temperatures facilitate the impurity removal process by adsorption. Second, it is one of the safest and most economical refrigerants that can be used to produce very low temperatures for any type of really low temperature operation. Other suitable liquefied gases include liquid Oxygen.

Porous glass may have several different trade names and may be produced by several different companies. It is understood that the physical properties of various brands of porous glass may vary somewhat from brand to brand. These kinds of property variations can typically be compensated for by adjusting the volume amounts of porous glass that may be used in any particular purification application.

It is well known that porous glass is produced from glass having two phases (one phase of the glass is soluble in acid while the other phase of the glass is insoluble in acid). The soluble phase is leached out of the glass with an acid leaving the insoluble portion behind. U.S. Pat. No. 2,106,744, U.S. Pat. No. 2,221,709, U.S. Pat. No. 2,286,275, and U.S. Pat. No. 3,485,687 contain lengthy descriptions of how to prepare porous glass, the contents of which are incorporated by reference. One type of granulated porous glass called controlled porosity glass (CPG) may be obtained from Prime Synthesis, Inc. (2 New Road, Suite 126, Aston, Pa. 19014) under the product name of Native-00500-CPG or Native-01000-CPG. Other granulated porous glass may also be obtained from Corning Inc. (One Riverfront Plaza, Corning, N.Y. 14831) and Advanced Glass and Ceramics (108 Valley Hill Drive—Holden Mass. —01520) under the product name of Vycor 7930.

Porous glass has a relatively high specific surface area due to the presence of pores, voids, micro-cracks, and surface imperfections. Typical BET surface areas of granulated porous glass are about 150 to 250 m²/g, more particularly either 150 to 200 m²/g or 200 to 250 m²/g. Typical average pore radii include about 40 Angstroms to about 3000 Angstroms. More particularly, typical average pore radii include: about 40 Angstroms to about 200 Angstroms; about 40 Angstroms to about 60 Angstroms; and about 75 Angstroms to about 3000 Angstroms. Typical non-limiting examples of porous glass compositions include: more than about 94% wt. of SiOH, about 4% wt. to about 6% wt. of B₂O₃, and about 0.25% wt. to about 1% wt. of either Na₂O or K₂O; more than about 94% wt. of SiOH, less than 6% wt. of B₂O₃, and less than about 1% wt. of either Na₂O or K₂O with the total wt. %'s of each of the SiOH, B₂O₃, and Na₂O or K₂O essentially equaling about 100; and more than about 94% wt. of SiOH, about 2% wt. to about 6% wt. of B₂O₃, and about 0.025% wt. to about 0.25% wt. of either Na₂O or K₂O.

The gas mixture which is to be purified contains at least a first gas and a second gas, wherein the first gas is preferentially adsorbed, and thereby removed, by the packed bed of porous gas. A non-limiting list of the first gas/second gas combinations include: Neon and Helium, Nitrogen and Helium, Argon and Helium, Oxygen and Helium, Methane and Helium, Krypton and Helium, Xenon and Helium, Carbon Dioxide and Helium, Water vapor and Helium, Nitrogen and Hydrogen, Argon and Hydrogen, Oxygen and Hydrogen, Methane and Hydrogen, Krypton and Hydrogen, Xenon and Hydrogen, Carbon Dioxide and Hydrogen, Water vapor and Hydrogen, Nitrogen and Neon, Argon and Neon, Oxygen and Neon, Methane and Neon, Krypton and Neon, Xenon and Neon, Carbon Dioxide and Neon, Water vapor and Neon, Argon and Nitrogen, Oxygen and Nitrogen, Methane and Nitrogen, Krypton and Nitrogen, Xenon and Nitrogen, Carbon Dioxide and Nitrogen, water vapor and Nitrogen, Methane and Argon, Krypton and Argon, Xenon and Argon, Carbon Dioxide and Argon, water vapor and Argon, Methane and Oxygen, Krypton and Oxygen, Xenon and Oxygen, Carbon Dioxide and Oxygen, water vapor and Oxygen, Xenon and Methane, Carbon Dioxide and Methane, water vapor and Methane; Xenon and Krypton, Carbon Dioxide and Krypton, water vapor and Krypton, and water vapor and Carbon Dioxide. Other gas mixtures for which the invention is applicable include one of the foregoing first gas/second gas examples that also includes one or two other gases each of which has a boiling point at one atmosphere that is at least 10°K higher than that of the second gas. Still another gas mixture for which the invention is applicable is the first gas/second gas combination of Krypton and Argon that also includes an amount of Xenon. This gas mixture may be separated into a predominantly Argon-containing purified gas and a gas mixture including major amounts of Krypton and Xenon.

Gas mixtures for which the method is particularly applicable include all of the above combinations in which the first gas is Helium, Hydrogen, Neon, Nitrogen, Argon, Oxygen, Methane, Krypton, or Xenon as well as the combination of Oxygen, Carbon Dioxide, and Water vapor. A gas mixture for which the method is especially applicable is Hydrogen and Methane.

In the case of a gas mixture of Oxygen, Carbon Dioxide, and water vapor, the packed bed of porous glass is maintained at a low temperature in a liquid Nitrogen or liquid Oxygen bath. The packed bed containing the Carbon Dioxide and water vapor may then be warmed and/or purged with a purge gas in order to remove the Carbon Dioxide and water vapor.

In the case of a gas mixture of Hydrogen and Methane, the Methane cannot be preferentially oxidized to convert it into Carbon Dioxide and water vapor because of the presence of the Hydrogen. However, the boiling point difference between Hydrogen and Methane is so great that that procedure is not necessary. Again these separations can be performed at temperatures in the vicinity of the normal boiling point of liquid nitrogen because the co-adsorption of either Helium or Hydrogen is minimal at these temperatures.

Other examples of this process will be apparent to one of ordinary skill in this art so a more exhaustive list of possibilities is not necessary.

It will be understood that many additional changes in the details materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above.

I claim:

1. A system for separating a gas mixture comprising two gases, comprising:
a) a source of a gas mixture, said gas mixture comprising first and second gases having boiling points or sublimation points at one atmosphere that are least 10°K apart;
b) at least one purification element operatively associated with said source of a gas mixture and being adapted and configured to selectively receive a flow of said gas mixture, said purification element comprising a vessel containing at least one packed bed of granulated porous glass; and
c) a purified gas conduit adapted and configured to receive a purified gas from said at least one purification unit and direct the purified gas to a container or point of use.

2. The system of claim 1, wherein the second gas is Helium.

3. The system of claim 1, wherein the second gas is Hydrogen.

4. The system of claim 1, wherein the first gas is Methane.

5. The system of claim 1, wherein the second gas is Argon.

6. The system of claim 1, wherein the first gas is CO₂ and the second gas is Oxygen.

7. The method of claim 1, wherein the granulated porous glass has a BET surface area of about 150 to 200 m²/g .

8. The method of claim 1, wherein the granulated porous glass has a BET surface area of about 200 to 250 m²/g.

9. The method of claim 1, wherein the granulated porous glass has an average pore radius of about 40 Angstroms to about 3000 Angstroms.

10. The method of claim 1, wherein the granulated porous glass has an average pore radius of about 40 Angstroms to about 200 Angstroms.

11. The method of claim 1, wherein the granulated porous glass has a composition comprising more than about 94% wt. of SiOH, about 4% wt. to about 6% wt. of B₂O₃, and about 0.25% wt. to about 1% wt. of R₂O, wherein R is either Na or K.

12. The method of claim 1, wherein the granulated porous glass has a composition consisting essentially of:
SiOH having a wt. % in the range of about >94 to less than 100;
B₂O₃ having a wt. % in the range of less than about 6; and
R₂O having a wt. % in the range of less than about 1, R being either Na or K.

13. The method of claim 1, wherein the granulated porous glass has a composition comprising more than about 94% wt. of SiOH, about 2% wt. to about 6% wt. of B₂O₃, and about 0.025% wt. to about 0.25% wt. of R₂O, wherein R is either Na or K.

14. The system of claim 1, wherein boiling points at 1 atmosphere of the first and second gases are at least 57°K apart.

15. The system of claim 1, wherein boiling points at 1 atmosphere of the first and second gases are at least 32°K apart.
